(19) United States
(12) Patent Application Publication
(10) Pub. No.: US 2026/0129315 A1
(43) Pub. Date: May 7, 2026

(54) IMAGING DEVICE AND METHOD FOR OPERATING THE SAME

(71) Applicant: SK hynix Inc., Icheon-si (KR)

(72) Inventors: Gon Ji LEE, Icheon-si (KR); Hyung Jun HAN, Icheon-si (KR)

(21) Appl. No.: 19/208,443

(22) Filed: May 14, 2025

(30) Foreign Application Priority Data
Nov. 1, 2024 (KR) 10-2024-0153644

(51) Int. Cl. H04N 25/633

(52) U.S. Cl. CPC H04N 25/633

(57) ABSTRACT

Imaging devices and methods of operating the same are disclosed. In an embodiment, an imaging device includes an active pixel array, an optical black pixel array, and a memory. The active pixel array includes a plurality of active pixels, each of which generates a pixel signal in response to incident light. The optical black pixel array includes a plurality of optical black pixels configured to generate dark signals for correcting dark noises of the plurality of active pixels. The memory stores matching data indicating a plurality of black regions in the optical black pixel array respectively matched with the plurality of active pixels.

### CROSS-REFERENCE TO RELATED APPLICATION

This patent document claims the priority and benefits of Korean patent application No. 10-2024-0153644, filed on Nov. 1, 2024, the disclosure of which is incorporated herein by reference in its entirety as part of the disclosure of this patent document.

### TECHNICAL FIELD

The technology and embodiments disclosed in this patent document generally relate to an imaging device, and more particularly to an imaging device including an image sensing device.

### BACKGROUND

An imaging device can output a final image by performing correction processes in an image processing device on a raw image generated by an image sensor embedded in the imaging device.

An image sensor is a device that captures optical raw images by converting light into electrical signals using a photosensitive semiconductor material that reacts to light. With advancements in industries such as automotive, medical, computer and communication industries, the demand for high-performance image sensors is increasing in various fields such as smartphones, digital cameras, game machines, IoT (Internet of Things), robots, security cameras and medical micro cameras.

The image sensor may be roughly divided into charge coupled device (CCD) image sensors and complementary metal oxide semiconductor (CMOS) image sensors. CCD image sensors offer a better image quality compared to the CMOS image sensors, but they tend to consume more power and are larger in size. CMOS image sensors are smaller in size and consume less power than CCD image sensors. Furthermore, CMOS image sensors are fabricated using the CMOS fabrication technology, and thus photosensitive elements and other signal processing circuitry can be integrated into a single chip, enabling the production of miniaturized image sensors at a lower cost. For these reasons, CMOS image sensors are being developed for many applications including mobile devices.

The image processing device is embedded in the imaging device, and may perform necessary corrections on the raw image to generate the final image.

### SUMMARY

Various embodiments of the disclosed technology relate to improving the quality of the final image output by the imaging device by correcting noise such as a dark current that is produced by an active pixel array included in an image sensor when no incident light is present or received by the active pixel array, and more particularly to technology for reducing a deviation that may occur between an average value of noise generated from the entire optical black pixel array which is an optical pixel array that is designed to block incident light so that the pixel signals are generated by the pixels in the optical black pixel array are caused by the dark current and an average value of noise generated from the entire active pixel array, thereby.

In an embodiment of the disclosed technology, a method for operating an imaging device may include: collecting a first pixel signal that is generated by a first active pixel included in an active pixel array in response to incident light; reading, from a memory, matching data indicating a first black region in an optical black pixel array corresponding to the first active pixel; collecting first dark signals that are generated by a plurality of first optical black pixels included in the first black region of the optical black pixel array; and correcting the first pixel signal using the first dark signals.

In some implementations, the reading the matching data may include: determining positions of the plurality of first optical black pixels included in the first black region.

In some implementations, the first pixel signal is generated by converting the first pixel signal into a first digital signal; and the first dark signals are generated by converting each of the first dark signals into a second digital signal.

In some implementations, the correcting the first pixel signal may include: calculating a first average by averaging the second digital signals.

In some implementations, the correcting the first pixel signal may include: subtracting the first average from the first digital signal.

In some implementations, the method may further comprise: collecting a second pixel signal that is generated by a second active pixel included in the active pixel array in response to the incident light; reading the matching data indicating a second black region in the optical black pixel array corresponding to the second active pixel; and collecting second dark signals that are generated by a plurality of second optical black pixels included in the second black region of the optical black pixel array.

In some implementations, the reading the matching data may further include: determining positions of the plurality of second optical black pixels included in the second black region.

In some implementations, the second pixel signal is generated by converting the second pixel signal into a third digital signal. The second dark signals are generated by converting each of the second dark signals into a fourth digital signal.

In some implementations, the method may further comprise: correcting the second pixel signal using the second dark signals, wherein the correcting the second pixel signal may include: calculating a second average indicating an average of the fourth digital signals.

In some implementations, the correcting the second pixel signal may further include: subtracting the second average from the third digital signal.

In another embodiment of the disclosed technology, an imaging device may include an image sensor including a pixel array configured to generate a plurality of pixel signals in response to incident light and a memory configured to store matching data for correcting the pixel signals. The pixel array may include: an active pixel array including a plurality of active pixels configured to generate the plurality of pixel signals; and an optical black pixel array including a plurality of optical black pixels configured to generate a plurality of dark signals for correcting the plurality of pixel signals. The matching data may indicate a plurality of black regions in the optical black pixel array respectively corresponding to the plurality of active pixels.

In some implementations, the matching data may indicate a position of each of optical black pixels included in a black region of the plurality of black regions.

In some implementations, the matching data may include: information to match a plurality of active regions, obtained by dividing the active pixel array, with one of the black regions and match a plurality of active pixels included in each of the active regions with a same black region from among the black regions.

In some implementations, an average of dark noises of active pixels included in an active region may be equal to an average of dark noises of optical black pixels included in a black region matched with the active region.

In some implementations, the image sensor may further include: a readout circuit configured to convert each of the plurality of pixel signals and each of the plurality of dark signals into digital signals.

In some implementations, the imaging device may further include: an image signal processor configured to calculate an average of the digital signals converted from the plurality of dark signals generated by optical black pixels included in the black region, subtracts the calculated average from the digital signal converted from a pixel signal generated by an active pixel matched with the black region, and corrects the pixel signal based on a result of subtraction.

In some implementations, the plurality of active pixels may include a first active pixel configured to generate a first pixel signal, and a second active pixel configured to generate a second pixel signal. The plurality of black regions may include a first black region matched with the first active pixel, and a second black region matched with the second active pixel.

In some implementations, the plurality of active pixels may further include: a third active pixel configured to generate a third pixel signal, wherein the third active pixel is matched with the first black region.

In some implementations, a portion of the first black region may be configured to overlap a portion of the second black region.

In some implementations, the first black region may be spaced apart from the second black region.

It is to be understood that both the foregoing general description and the following detailed description of the disclosed technology are illustrative and explanatory and are intended to provide further explanation of the disclosure as claimed.

### BRIEF DESCRIPTION OF THE DRAWINGS

The above and other features and beneficial aspects of the disclosed technology will become readily apparent with reference to the following detailed description when considered in conjunction with the accompanying drawings.

FIG. 1 is a block diagram illustrating an example of an imaging device and an image test device based on some implementations of the disclosed technology.

FIG. 2 is a flowchart illustrating an example of a method for matching a part of an optical black pixel array with an active pixel in order for an image test device to remove dark noise components of a pixel signal generated by an active pixel arranged in an active pixel array of the imaging device shown in FIG. 1 based on some implementations of the disclosed technology.

FIG. 3A is a diagram illustrating an example of the result of performing operation S110 of FIG. 2 based on some implementations of the disclosed technology.

FIG. 3B is a diagram illustrating an example of the result of performing operations S120 and S130 of FIG. 2 based on some implementations of the disclosed technology.

FIG. 4A is a diagram illustrating an example of the result of re-performing operation S110 of FIG. 2 based on some implementations of the disclosed technology.

FIG. 4B is a diagram illustrating an example of the result of re-performing operations S120 and S130 of FIG. 2 based on some implementations of the disclosed technology.

FIG. 5A is a diagram illustrating an example of a plurality of black regions serving as a portion of the optical black pixel array of FIG. 2 based on some implementations of the disclosed technology.

FIG. 5B is a diagram illustrating an example of the result of performing operation S140 of FIG. 2 based on some implementations of the disclosed technology.

FIG. 5C is a diagram illustrating an example of the result of performing operation S150 of FIG. 2 based on some implementations of the disclosed technology.

FIG. 6 is a flowchart illustrating an example of a method for operating the imaging device of FIG. 1 based on some implementations of the disclosed technology.

### DETAILED DESCRIPTION

This patent document provides embodiments and examples of an imaging device including an image sensor (or image sensing device) that may be used in configurations to substantially address one or more technical or engineering issues and to mitigate limitations or disadvantages encountered in some image sensing devices in the art. An image sensor based on the disclosed technology includes both an active pixel array with pixels to detect incident light to produce active pixel signals that capture images in the incident light and a “black” pixel array with pixels implemented with a light block structure that blocks light from the pixels in the black pixel array so that the pixel signals in the block pixel array are signals caused the dark currents in the pixels. The disclosed technology can be implemented in some embodiments to correct noise such as dark current of an active pixel array included in an image sensor. Specifically, the disclosed technology can be implemented in some embodiments to reduce deviations that may occur between an average value of noise generated by the entire optical black pixel array and an average value of noise generated by the entire active pixel array, thereby improving the quality of a final image generated by an imaging device. In recognition of the issues above, the disclosed technology can be implemented in some embodiments to provide an imaging device that reduces a deviation between noise occurring in the active pixel array of the image sensor and noise occurring in the optical black pixel array of the image sensor, thereby enabling more precise noise correction.

Reference will now be made in detail to the embodiments of the disclosed technology, examples of which are illustrated in the accompanying drawings. Wherever possible, the same reference numbers will be used throughout the drawings to refer to the same or like parts.

Hereinafter, various embodiments will be described with reference to the accompanying drawings. However, it should be understood that the disclosed technology is not limited to specific embodiments, but includes various modifications, equivalents and/or alternatives of the embodiments. The embodiments of the disclosed technology may provide a variety of effects capable of being directly or indirectly recognized through the disclosed technology.

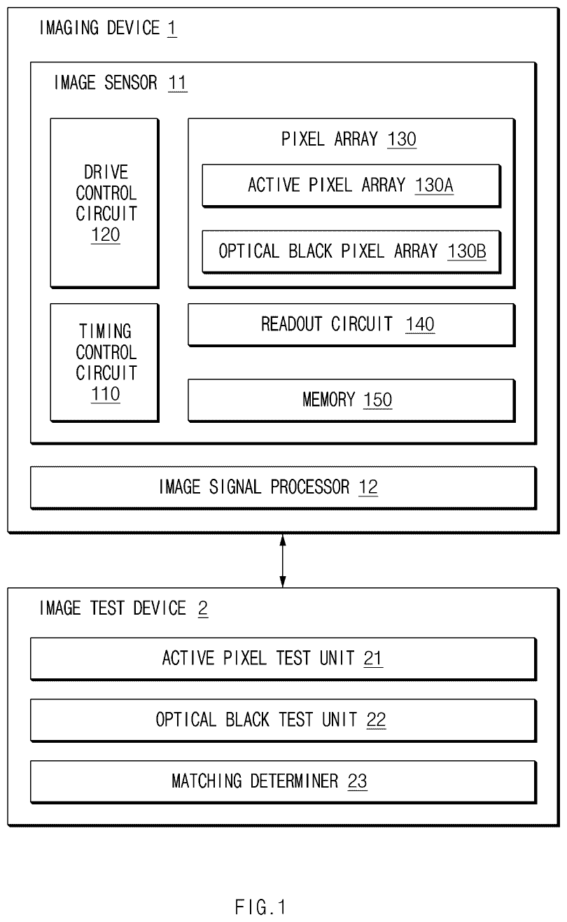

FIG. 1 is a block diagram illustrating an example of an imaging device 1 and an image test device 50 based on some implementations of the disclosed technology.

Referring to FIG. 1, the imaging device 1 may include an image sensor 1 and an image signal processor 12. The imaging device 1 may be an electronic device that includes a photographing function, such as a camera, a smartphone, or others.

The image sensor 11 may include a timing control circuit 110, a drive control circuit 120, a pixel array 130, a readout circuit 140, and a memory 150. In an embodiment, the memory 150 may exist separately from the image sensor 11 in the imaging device 1. In another embodiment, as shown in FIG. 1, the memory 150 may be arranged in the image sensor 11.

The timing control circuit 110 may provide timing signals and control signals to at least one of the drive control circuit 120 and the readout circuit 140.

The drive control circuit 120 may activate the pixel array 130 to perform specific operations on pixels included in a corresponding row based on timing signals and control signals received from the timing control circuit 110.

In some implementations, the drive control circuit 120 may select at least one pixel arranged in at least one row of the pixel array 130, and may provide the selected pixel with a control signal for performing a specific operation. The drive control circuit 120 may generate a row selection signal to select at least one row from among a plurality of rows. When the drive control circuit 120 selects a specific row from among the plurality of rows to perform a specific operation, the drive control circuit 120 may not perform the specific operation on a row adjacent to the selected row.

The pixels of the row selected by the drive control circuit 120 may sequentially transfer analog reference signals and image signals to the readout circuit 140. The reference signal may be an electrical signal provided to the readout circuit 140 when a floating diffusion (FD) region of each pixel is reset to a power-supply voltage. The image signal may be an electrical signal provided to the readout circuit 140 and may correspond to photocharges generated by each pixel that are accumulated in the floating diffusion (FD) region.

In some implementations, the reference signal may be a signal indicating unique pixel noise of each pixel, and the reference signal and the image signal may be collectively referred to as a pixel signal.

The pixel array 130 may include a plurality of pixels arranged in a plurality of rows and a plurality of columns. The plurality of pixels may be connected to the drive control circuit 120 through a plurality of row lines extending in the row direction. The plurality of pixels may be connected to the readout circuit 140 through a plurality of column lines extending in the column direction. The pixel array 130 may include at least one pixel arranged in the row direction and the column direction. For example, the pixel array 130 may be arranged in a two-dimensional (2D) pixel array in which a plurality of unit pixels is arranged in rows and columns.

The plurality of unit pixels included in the pixel array 130 may convert optical signals into electrical signals (e.g., image signal, dark current), and may be connected to a specific internal circuit. In some embodiments, the plurality of unit pixels in the pixel array 130 may include unit pixels (e.g., active pixels) that generate electrical signals used to generate images, and unit pixels (e.g., optical black pixel) that generate dark current used to correct dark noise of the active pixel array. In some embodiments, to distinguish between an electrical signal generated by an active pixel and an electrical signal generated by an optical black pixel, the electrical signal or dark current generated by the optical black pixel can be referred to as “dark signal.”.

The pixel array 130 may receive a pixel control signal including a row selection signal, a pixel reset signal, a row transfer signal, etc. from the drive control circuit 120. At least one pixel included in the row that is selected by the drive control circuit 120 according to the pixel control signal may perform a specific operation in response to the row selection signal, the pixel reset signal, and the row transfer signal.

The pixel array 130 may include an active pixel array 130A and an optical black pixel array 130B.

The active pixel array 130A may be a region that generates a pixel signal in response to incident light received from the outside. The optical black pixel array 130B may be a region that generates a dark signal that can be used to correct the dark noise of the active pixel array 130A.

The active pixel array 130A may include a plurality of active pixels. The plurality of active pixels may be arranged, for example, in a two-dimensional configuration. In an embodiment in which the plurality of active pixels is arranged in a two-dimensional configuration, the plurality of active pixels may be arranged in the row direction and the column direction.

The active pixel may generate a pixel signal in response to incident light. Among light beams incident upon the active pixel, light having a specific wavelength band (e.g., red light, green light, or blue light) may pass through an optical filter arranged in the active pixel and then focused onto a photoelectric conversion element. The photoelectric conversion element may generate photocharges in response to incident light. The active pixel may generate electrical signals in response to the amount of generated photocharges.

The active pixel may generate a pixel signal even in a situation where the amount of incident light is very small or absent (hereinafter referred to as “dark condition”). A signal generated under the dark condition may be a signal corresponding to a noise component occurring in the image sensor 11. In some embodiments, the noise component in the pixel signal generated by the active pixel under the dark condition or the noise component in the dark signal generated by the optical black pixel may be referred to as “dark noise.”

Since the dark noise component is also present in the pixel signal generated by the active pixel even under illuminated conditions, a correction process (dark noise correction process) may be performed to remove or reduce the dark noise component included in the pixel signal. The correction process may be performed, for example, by the image signal processor 12.

The optical black pixel array 130B may be a region arranged adjacent to the active pixel array 130A within the pixel array 130. The optical black pixel array 130B may be arranged, for example, to be in contact with one side of the active pixel array 130A. In another embodiment, the optical black pixel array 130B may be arranged to be in contact with two, three or four sides of the active pixel array 130A.

The optical black pixel array 130B may include a plurality of optical black pixels. The optical black pixel may have a structure similar to that of the active pixel, but may further include a light blocking structure. The light blocking structure may include a material having a high light absorption rate or high light reflectivity. The light blocking structure may block incident light from reaching a photoelectric conversion element within the optical black pixel. The optical black pixel may generate a dark signal as described in reference to FIG. 1. Since the optical black pixel includes the light blocking structure, the dark signal may represent dark noise.

The readout circuit 140 may sample electrical signals output from the pixel array 130, may convert the electrical signals into digital signals, and may output the digital signals to the image signal processor 12. The readout circuit 140 may include, for example, a correlated double sampler (CDS), an analog-to-digital converter (ADC), an output buffer, a column driver, etc.

For example, the CDS may receive the reference signal and the image signal, each of which corresponds to the columns of the pixel array 130, and may sample voltage levels of the reference signal and the image signal. In CMOS-based image sensing devices, the CDS may sample a pixel signal twice to remove a difference between these two samples, and may perform correlated double sampling to remove undesired offset values of pixels such as fixed noise. For example, the CDS may compare pixel output voltages obtained before and after photocharges generated by incident light are accumulated in the floating diffusion region to remove undesired offset values, ensuring the pixel output voltages accurately reflect the incident light.

The CDS may transmit reference signals and image signals, which are generated in the columns of the pixel array 130 based on a timing signal and a control signal of the timing controller, to the ADC as CDS signals.

For example, the ADC may convert an analog CDS signal received from the CDS into a digital signal, and may output the digital signal. The output buffer may temporarily hold and output the digital signal received from the ADC 140. A column driver may select a column from the output buffer based on the timing signal and the control signal of the timing control circuit 110, and may control the temporarily held digital signals to be output in the designated order.

A memory 150 may be a storage device that stores data. The memory 150 may store correction parameters (e.g., correction gain) used for image correction. The memory 150 may be implemented as a non-volatile memory. For example, the memory 150 may include various non-volatile memory devices such as a read only memory (ROM) that can only read data, a one-time programmable (OTP) memory that can write data only once, an erasable and programmable ROM (EPROM) memory that can erase and read the stored data, a NAND flash memory, a NOR flash memory, and other memory devices. The memory 150 may be integrated within the image sensor 11 or may be installed separately from the image sensor 11. FIG. 1 illustrates an embodiment in which the memory 150 is disposed in the image sensor 11.

The image signal processor 12 may be a device that corrects data (e.g., raw image data) output from the image sensor 11. The image signal processor 12 may perform corrections to reduce either electrical noise generated from the image sensor 11 or noise in an image captured under the low-illuminance environment. When the image sensor 11 utilizes an optical filter array in a Bayer pattern, each pixel outputs information for a single primary color as an electrical signal. In such cases, the image signal processor 12 may perform a demosaicing operation to determine a color using electrical signals of adjacent pixels. In addition, the image signal processor 12 may correct lens shading that occurs due to lens characteristics.

In some implementations, the image signal processor 12 may perform a dark noise correction process (a correction process for removing the dark noise component) using the pixel signal and the dark signal. The image signal processor 12 may subtract the intensity of the dark signal from the intensity of the pixel signal, and may thus generate a pixel signal with the dark noise component removed or reduced.

The image signal processor 12 may calculate the average intensity of the dark signals generated by the optical black pixels included in the optical black pixel array 130B, may subtract the calculated average from the intensity of the pixel signal generated by each of the active pixels, thereby removing or reducing the dark noise component. In this process, the image signal processor 12 may perform noise correction using a value that is different from the actual dark noise present in the actual pixel signal. This difference may arise due to deviations or defects in each semiconductor chip region that may occur based on the condition of a semiconductor chip in which the image sensor 11 is implemented.

In addition, even when noise correction is performed by calculating an average intensity of the dark signals generated by the optical black pixels in the optical black pixel array 130B in the same row or column as the active pixel array 130A and then subtracting the average intensity of the dark signals from the intensity of the pixel signal generated by each of the active pixels in the same row or column as the optical black pixel array 130B, the noise correction may still use a value different from the actual noise in the actual pixel signal. This discrepancy can arise due to factors such as noise deviation, which may vary depending on the condition of the semiconductor chip. For example, if a defect occurs in a part of the semiconductor chip due to variations or defects in the fabrication process of the semiconductor chip, a significant noise deviation may occur.

In addition, as the size of the semiconductor chip increases, variations of dark noise values among the active pixels or optical black pixels depending on the pixel positions within the semiconductor chip may become more substantial, potentially reducing the accuracy of noise correction.

The image test device 2 may be used to determine a correction parameter that allows the imaging device 11 to correct images. The image test device 2 may include an active pixel test unit 21, an optical black pixel test unit 22, and a matching determiner 23.

The active pixel test unit 21 may test or analyze the noise within the active pixel region of the pixel array 130. For example, the active pixel test unit 21 may calculate the noise and noise deviation for the entire active pixel array 130A or a portion of the active pixel array 130A.

The optical black pixel test unit 22 may test or analyze the noise within the optical black pixel region of the pixel array 130. For example, the optical black pixel test unit 22 may calculate the dark noise and deviation of dark noise for the entire optical black pixel array 130B or a portion of the optical black pixel array 130B.

The matching determiner 23 may match black regions, which are part of the optical black pixel array 130B, with a portion of the active pixel array 130A or individual active pixels by using the noise and noise deviation calculated by the active pixel test unit 21 and the optical black pixel test unit 22. The matched information may be stored in the memory 150.

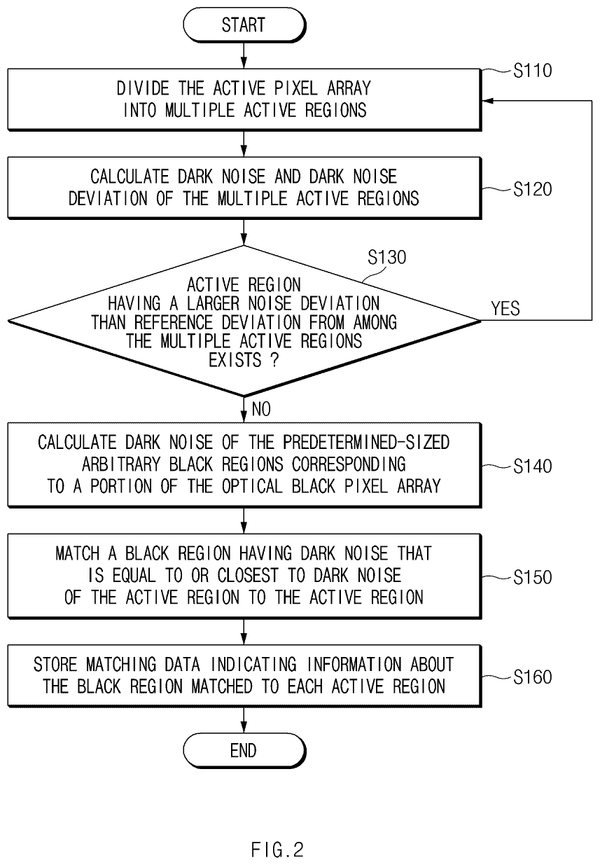

FIG. 2 is a flowchart illustrating an example of a method for matching a part of the optical black pixel array 130B with the active pixel for the image test device 2 to remove dark noise components of the pixel signal generated by the active pixel arranged in the active pixel array 130A of the imaging device 1 shown in FIG. 1 based on some implementations of the disclosed technology.

Referring to FIGS. 1 and 2, the active pixel test unit 21 may divide the active pixel array 130A into a plurality of active regions (S110). For example, the active pixel array 130A may be divided into N active regions (where N is an integer greater than or equal to 2). The sizes of the N active regions may be the same, or some or all of the N active regions may be different from each other.

The active pixel test unit 21 may calculate the dark noise of each of the plurality of active regions and a deviation of the dark noise of the plurality of active regions (S120). The dark noise may refer to the noise of the active pixel array 130A under the dark conditions. In an embodiment, the noise of a specific region may refer to the average noise of all pixels included in the specific region. The dark noise deviation may refer to a deviation of dark noise of the pixels included in the specific region under dark conditions (e.g., conditions with very little or no light).

The active pixel test unit 21 may determine whether there is an active region having a dark noise deviation greater than a reference deviation from among the plurality of active regions (S130). In an embodiment, the reference deviation may be a value pre-stored in the active pixel test unit 21. In another embodiment, the reference deviation may be a value arbitrarily set by a user who operates the image test device 2.

If there is an active region having a dark noise deviation greater than the reference deviation from among the multiple active regions (“YES” in S130), the active pixel test unit 21 may divide the active pixel array 130 into M active regions (where M is an integer greater than or equal to 2) (S110). The sizes of the multiple active regions may be the same or some or all of the multiple active regions may be different from each other. In an embodiment, M may be an integer greater than N. For example, each of the active regions having a dark noise deviation greater than the reference deviation may be divided into smaller active regions.

The active pixel test unit 21 may calculate the dark noise of each of the multiple active regions and a deviation of the dark noises of the multiple active regions (S120).

If none of the active regions have a dark noise deviation greater than the reference deviation (“NO” in S130), the optical black pixel test unit 22 may calculate the dark noise of each arbitrary black region, which is part of the optical black pixel array (S140). The sizes of the arbitrary black regions may be uniform.

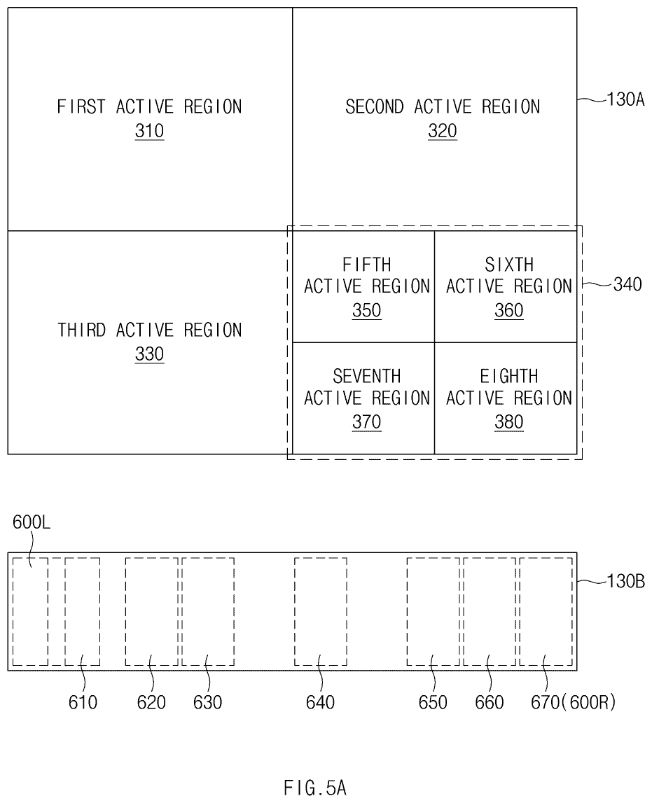

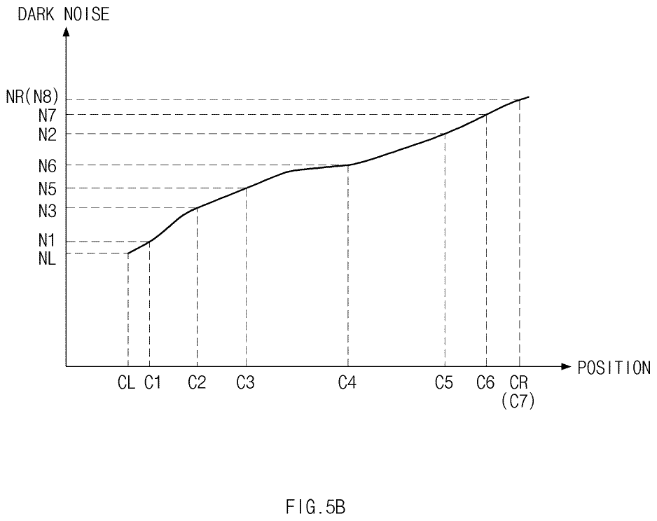

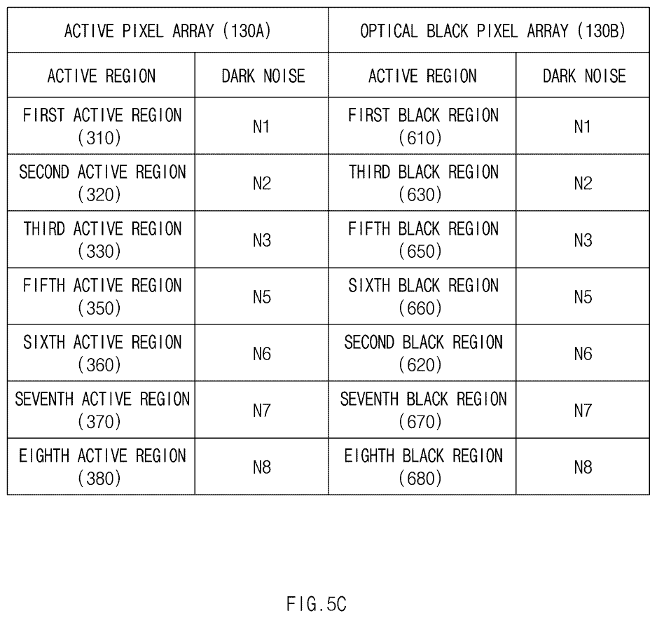

For example, the optical black pixel test unit 22 may calculate the dark noise of each arbitrary black region while shifting a preset region (hereinafter referred to as “monitoring region”) from one side to the other side of the optical black pixel array 130B, and at the same time the optical black pixel test unit 22 may calculate the dark noise of the monitoring region. An example of calculating the dark noise of the monitoring region will be further described with reference to FIG. 5B below.

The matching determiner 23 may match a black region having dark noise that is equal to or closest to the calculated dark noise (obtained in S120) of the active region, with the active region (S150). For example, the matching determiner 23 may match a black region with an active region or map the black region to the active region based on the similarity of their dark noise.

The matching determiner 23 may determine matching data indicating information about the black regions respectively matched to the active regions to be a correction parameter for removing dark noise components of the pixel signal, and may store the correction parameter in the memory 150 of the imaging device 1.

In an embodiment, the operations in the flowchart shown in FIG. 2 can be performed as will be described in more detail.

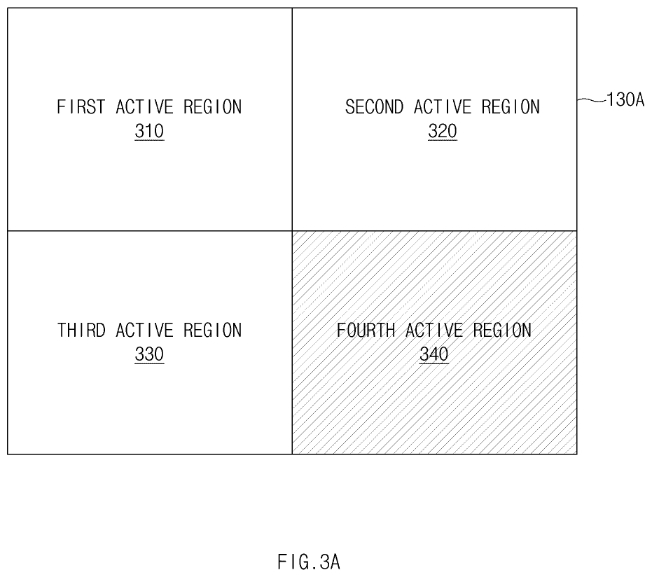

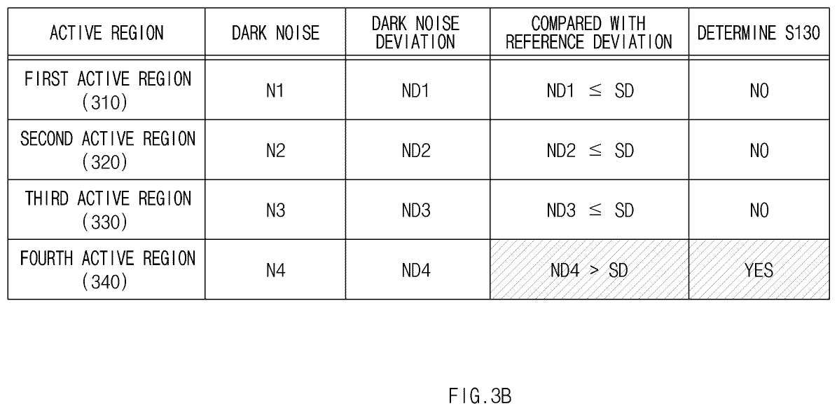

FIG. 3A is a diagram illustrating an example of the result of performing operation S110 of FIG. 2 based on some implementations of the disclosed technology.

FIG. 3B is a diagram illustrating an example of the result of performing operations S120 and S130 of FIG. 2 based on some implementations of the disclosed technology.

Referring to FIGS. 1 to 3B, the active pixel test unit 21 may divide the active pixel array 130A into first to fourth active regions (310, 320, 330, 340) (S110).

The active pixel test unit 21 may calculate the dark noise of each of the first to fourth active regions (310, 320, 330, 340) and a deviation of the calculated dark noises of the first to fourth active regions (310, 320, 330, 340) (S120).

The average dark noise of the plurality of active pixels included in the first active region 310 may be a first dark noise (N1). The deviation of the dark noises of the plurality of active pixels included in the first active region 310 may be a first dark noise deviation (ND1).

The average dark noise of the plurality of active pixels included in the second active region 320 may be a second dark noise (N2). The deviation of the dark noises of the plurality of active pixels included in the second active region 320 may be a second dark noise deviation (ND2).

The average dark noise of the plurality of active pixels included in the third active region 330 may be a third dark noise (N3). The deviation of the dark noises of the plurality of active pixels included in the third active region 330 may be a third dark noise deviation (ND3).

The average dark noise of the plurality of active pixels included in the fourth active region 340 may be a fourth dark noise (N4). The deviation of the dark noises of the plurality of active pixels included in the fourth active region 340 may be a fourth dark noise deviation (ND4).

The active pixel test unit 21 may determine the presence or absence of the active region having a dark noise deviation greater than the reference deviation (SD) for each of the first to fourth active regions (310, 320, 330, 340) (S130).

In an example, each of the first to third dark noise deviations (ND1, ND2, ND3) is less than or equal to the reference deviation (SD), while the fourth dark noise deviation (ND4) is greater than the reference deviation (SD).

In this case, the active pixel test unit 21 may determine that the fourth active region 340 has a dark noise deviation greater than the reference deviation (SD) (YES in S130).

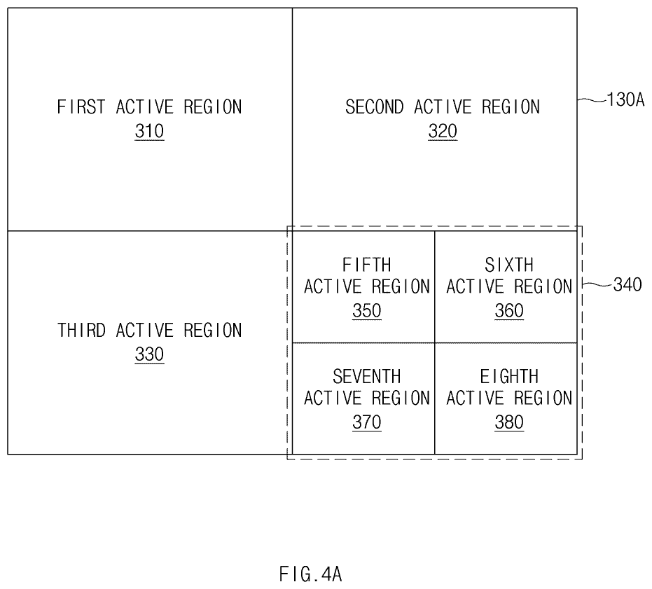

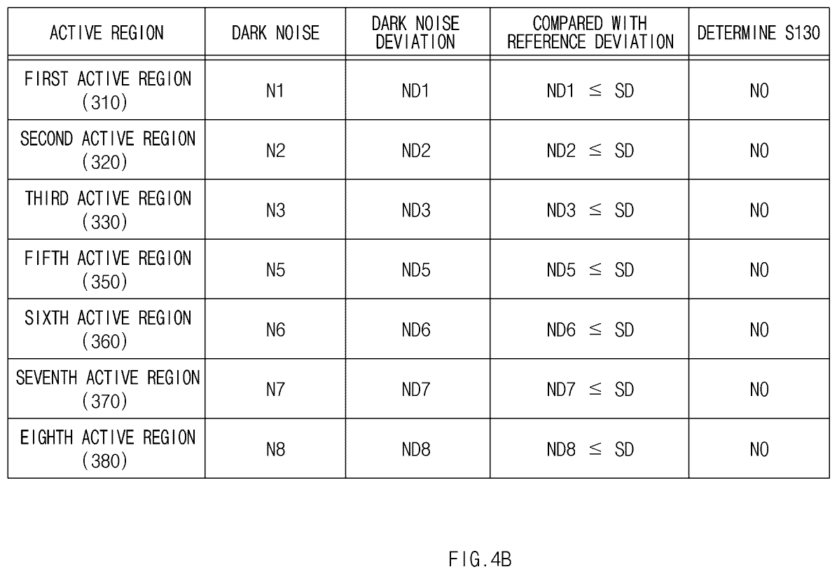

FIG. 4A is a diagram illustrating an example of the result of re-performing operation S110 of FIG. 2 based on some implementations of the disclosed technology.

FIG. 4B is a diagram illustrating an example of the result of re-performing operations S120 and S130 of FIG. 2 based on some implementations of the disclosed technology.

Hereinafter, descriptions overlapping with those of FIGS. 3A and 3B will be omitted as much as possible.

Referring to FIGS. 1 to 4B, the active pixel test unit 21 may divide the active pixel array 130A into first to third active regions (310, 320, 330) and fifth to eighth active regions (350, 360, 370, 380) (S110). Here, the fifth to eighth active regions (350, 360, 370, 380) are obtained by dividing the fourth active region 340 having a dark noise deviation greater than the reference deviation (SD).

The active pixel test unit 21 may calculate the dark noise of each of the first to third active regions (310, 320, 330) and the fifth to eighth active regions (350, 360, 370, 380), and may calculate a deviation of the calculated dark noises of the first to third active regions (310, 320, 330) and the fifth to eighth active regions (350, 360, 370, 380) (S120).

The average dark noise of the plurality of active regions included in the fifth active region 350 may be a fifth dark noise (N5). The deviation of the calculated dark noises of the plurality of active pixels included in the fifth active region 350 may be a fifth dark noise deviation (ND5).

The average dark noise of the plurality of active regions included in the sixth active region 360 may be a sixth dark noise (N6). The deviation of the calculated dark noises of the plurality of active pixels included in the sixth active region 360 may be a sixth dark noise deviation (ND6).

The average dark noise of the plurality of active regions included in the seventh active region 370 may be a seventh dark noise (N7). The deviation of the calculated dark noises of the plurality of active pixels included in the fifth active region 370 may be a seventh dark noise deviation (ND7).

The average dark noise of the plurality of active regions included in the eighth active region 380 may be an eighth dark noise (N8). The deviation of the calculated dark noises of the plurality of active pixels included in the eighth active region 380 may be an eighth dark noise deviation (ND8).

The active pixel test unit 21 may determine the presence or absence of the active region having a dark noise deviation greater than the reference deviation (SD) for each of the first to third active regions (310, 320, 330) and the fifth to eighth active regions (350, 360, 370, 380) (S130).

In this example, each of the first to third dark noise deviations (ND1, ND2, ND3) and the fifth to eighth dark noise deviations (ND5, ND6, ND7, ND8) is less than or equal to the reference deviation (SD).

The active pixel test unit 22 may determine the absence of the active region having a dark noise deviation greater than the reference deviation (SD) from among the first to third active regions (310, 320, 330) and the fifth to eighth active regions (350, 360, 370, 380) (NO in S130).

FIG. 5A is a diagram illustrating an example of the plurality of black regions serving as a portion of the optical black pixel array 130B shown in FIG. 2 based on some implementations of the disclosed technology.

Referring to FIGS. 1, 2, and 5A, the optical black pixel test unit 22 may determine one or more black regions by measuring the dark noise of the optical black pixel array 130B while shifting the monitoring region of a fixed size from one side (e.g., the left side) to the other side (e.g., the right side) of the optical black pixel array 130B.

When a monitoring region located on one side of the optical black pixel array 130B is referred to as a first monitoring region 600L, and a monitoring region located on the other side of the optical black pixel array 130B is referred to as a second monitoring region 600R, an example of the dark noise calculated while shifting the monitoring region from the first monitoring region 600L to the second monitoring region 600R is shown in FIG. 5B.

Each of the first to seventh black regions (610, 620, 630, 640, 650, 660, 670) may be a part of the optical black pixel array 130B. Each of the first to third active regions (310, 320, 330) and the fifth to eighth active regions (350, 360, 370, 380) may be matched to any one of the first to seventh black regions (610, 620, 630, 640, 650, 660, 670).

Although FIG. 5A shows an embodiment in which the respective black regions are spaced apart from each other for convenience of description, the scope or spirit of the disclosed technology is not limited thereto, and other embodiments in which the black regions partially overlap each other are also possible.

FIG. 5B is a diagram illustrating an example of the result of performing operation S140 of FIG. 2 based on some implementations of the disclosed technology.

Referring to FIGS. 1, 2, 4B, 5A, and 5B, the optical black pixel test unit 22 may calculate the dark noise while moving the monitoring region from one side to the other side. For example, the dark noise in the first monitoring region 600L may be a ninth dark noise (NL). The dark noise in the second monitoring region 600R may be a tenth dark noise (NR).

In an embodiment, the calculated dark noise may increase as the monitoring region moves. The dark noise tends to increase as the size of the photoelectric conversion element included in the pixel increases. For example, when the size of the photoelectric conversion element of each optical black pixel is designed to increase from one side to the other side of the optical black pixel array 130B, the dark noise may increase as the monitoring region moves.

The horizontal axis of the graph of FIG. 5B may mean the position of the center of the monitoring region having a constant size, and the vertical axis of the graph of FIG. 5B may mean the calculated dark noise.

Each of the first to seventh positions (C1-C7) may represent the center position of each of the first to seventh black regions (610, 620, 630, 640, 650, 660). The eighth position (CL) may represent the center position of the first monitoring region 600L. The ninth position (CR) may represent the center position of the second monitoring region 600R.

In this example, the position of the monitoring region having the first dark noise (N1) may be the first position (C1). The position of the monitoring region having the second dark noise (N2) may be the fifth position (C5). The position of the monitoring region having the third dark noise (N3) may be the second position (C2). The position of the monitoring region having the fifth dark noise (N5) may be the third position (C3). The position of the monitoring region having the sixth dark noise (N6) may be the fourth position (C4). The position of the monitoring region having the seventh dark noise (N7) may be the sixth position (C6). The position of the monitoring region having the eighth dark noise (N8) may be the eighth position (C8).

FIG. 5C is a diagram illustrating an example of the result of performing operation S150 of FIG. 2 based on some implementations of the disclosed technology.

Referring to FIGS. 1, 2, and 5A to 5C, the matching determiner 23 may determine a black region having dark noise that is equal to or closest to dark noise of each of the first to third active regions (310, 320, 330) and the fifth to eighth active regions (350, 360, 370, 380) (S150).

The matching determiner 23 may match the first black region 610 to the first active region 310, or may match the first black region 610 to each of the plurality of active regions included in the first active region 310.

The matching determiner 23 may match the third black region 630 to the second active region 320, or may match the third black region 630 to each of the plurality of active regions included in the second active region 320.

The matching determiner 23 may match the fifth black region 650 to the third active region 330, or may match the fifth black region 650 to each of the plurality of active regions included in the third active region 330.

The matching determiner 23 may match the sixth black region 660 to the fifth active region 350, or may match the sixth black region 660 to each of the plurality of active regions included in the fifth active region 350.

The matching determiner 23 may match the second black region 620 to the sixth active region 360, or may match the second black region 620 to each of the plurality of active regions included in the sixth active region 360.

The matching determiner 23 may match the seventh black region 670 to the seventh active region 370, or may match the seventh black region 670 to each of the plurality of active regions included in the seventh active region 370.

The matching determiner 23 may match the eighth black region 680 to the eighth active region 380, or may match the eighth black region 680 to each of the plurality of active regions included in the eighth active region 380.

The matching data, which includes information on each of the matched black regions, may be stored in the memory 150. The matching data may include, for example, information on the position of each of the optical black pixels included in the black region.

In an embodiment, the dark noise of an active region is equal to the dark noise of a black region matched with (or mapped to) the active region. In another embodiment, when there is no black region having the same dark noise as the dark noise of the active region, the matching determiner 23 may determine the black region having the closest approximate dark noise among the calculated dark noises of the monitoring region, as a black region to be matched to the active region.

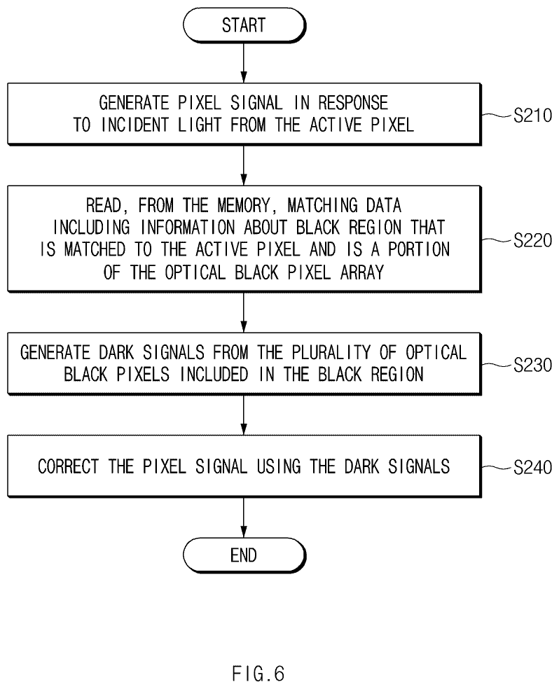

FIG. 6 is a flowchart illustrating an example of a method for operating the imaging device 1 of FIG. 1 based on some implementations of the disclosed technology.

Referring to FIGS. 1, 5A, 5C, and 6, the active pixel array 130A may enable each of the active pixels to generate a pixel signal in response to incident light (S210). For example, a first active pixel included in a first active region 310 may generate a first pixel signal in response to incident light.

The generated pixel signal (e.g., the first pixel signal) may be converted into a digital signal through the readout circuit 140 and output to, for example, the image signal processor 12. In an embodiment, the method for operating the imaging device 1 of FIG. 1 comprises collecting the first pixel signal that is generated by the first active pixel.

The image signal processor 12 may read, from the memory 150, matching data including information on a black region that is matched to the active pixel and is part of the optical black pixel array 130B) (S220). In an embodiment, the method for operating the imaging device 1 comprises reading, from the memory, matching data indicating a first black region that corresponds to the first active pixel and is in an optical black pixel array that is designed to block incident light from entering pixels in the optical block pixel array. The image signal processor 12 may determine, based on the read matching data, the position of each of the plurality of optical black pixels included in the black region matched to the active pixel. For example, when the first pixel signal is converted into a digital signal and output to the image signal processor 12, the image signal processor 12 may read information about the first black region 610 (i.e., the position of the first black region 610 within the optical black pixel array) matched to the first active pixel. The image signal processor 12 may determine the positions of the plurality of optical black pixels included in the first black region 610.

The optical black pixel array 130B may generate dark signals from the plurality of optical black pixels included in the black region (e.g., the first black region 610) (S230). For example, the optical black pixel array 130B may generate dark signals from the plurality of optical black pixels included in the first black region 610 matched to the first active pixel.

Each of the generated dark signals may be converted into a digital signal through the readout circuit 140 and output to, for example, the image signal processor 12. In an embodiment, the method for operating the imaging device 1 comprising collecting first dark signals that are generated by a plurality of first optical black pixels included in the first black region of the optical black pixel array.

The image signal processor 12 may remove dark noise components of the pixel signal using the dark signals converted into the digital signals (S240). For example, the image signal processor 12 may calculate a first average indicating the average of the dark signals converted into the digital signals. The image signal processor 12 may subtract the first average from the first pixel signal converted into the digital signal to remove the dark noise components of the first pixel signal.

The series of the operations of S210 to S240 may be repeated for each pixel.

For example, the active pixel array 130A may generate a second pixel signal in response to incident light in a second active pixel included in the second active region 320 (S210). The second pixel signal may be converted into a digital signal through the readout circuit 140 and the digital signal may be output to the image signal processor 12.

When the second pixel signal is converted into a digital signal and output to the image signal processor 12, the image signal processor 12 may determine the positions of the plurality of optical black pixels included in the third black region 630 matched to the second active pixel (S220).

The optical black pixel array 130B may generate dark signals from the plurality of optical black pixels included in the third black region 630 matched to the second active pixel (S230). Each of the generated dark signals may be converted into a digital signal through the readout circuit 140 and the digital signal may be output to, for example, the image signal processor 12.

The image signal processor 12 may calculate a second average indicating the average of the dark signals converted into digital signals, and may subtract the second average from the second pixel signal converted into the digital signal to remove the dark noise components of the second pixel signal.

The active pixel array 130A may generate a third pixel signal in response to incident light from a third active pixel included in the first active region 320 (S110). The third pixel signal may be converted into a digital signal through the readout circuit 140 and the digital signal may be output to the image signal processor 12.

When the third pixel signal is converted into a digital signal and output to the image signal processor 12, the image signal processor 12 may determine the positions of the plurality of optical black pixels included in the first black region 610 matched to the third active pixel (S220).

The optical black pixel array 130B may generate dark signals from the plurality of optical black pixels included in the first black region 610 matched to the second active pixel (S230). Each of the generated dark signals may be converted into a digital signal through the readout circuit 140 and output to, for example, the image signal processor 12.

The image signal processor 12 may calculate a third average indicating the average of dark signals converted into digital signals, and may subtract the third average from the third pixel signal converted into the digital signal to remove dark noise components of the third pixel signal.

As is apparent from the above description, the imaging device based on some embodiments of the disclosed technology may reduce a deviation between noise occurring in the active pixel array of the image sensor and noise occurring in the optical black pixel array of the image sensor, thereby enabling more precise noise correction.

The embodiments of the disclosed technology may provide a variety of effects capable of being directly or indirectly recognized through the above-mentioned patent document.

Although a number of illustrative embodiments have been described, it should be understood that modifications and enhancements to the disclosed embodiments and other embodiments can be devised based on what is described and/or illustrated in this patent document.

What is claimed is:

1. A method for operating an imaging device comprising:
collecting a first pixel signal that is generated by a first active pixel included in an active pixel array in response to incident light;
reading, from a memory, matching data indicating a first black region that corresponds to the first active pixel and is in an optical black pixel array that is designed to block incident light from entering pixels in the optical block pixel array;
collecting first dark signals that are generated by a plurality of first optical black pixels included in the first black region of the optical black pixel array; and
correcting the first pixel signal using the first dark signals.

2. The method according to claim 1, wherein the reading the matching data includes:
determining positions of the plurality of first optical black pixels included in the first black region.

3. The method according to claim 1, wherein:
the first pixel signal is generated by converting the first pixel signal into a first digital signal; and
the first dark signals are generated by converting each of the first dark signals into a second digital signal.

4. The method according to claim 3, wherein the correcting the first pixel signal includes:
calculating a first average by averaging the second digital signals.

5. The method according to claim 4, wherein the correcting the first pixel signal includes:
subtracting the first average from the first digital signal.

6. The method according to claim 1, further comprising:
collecting a second pixel signal that is generated by a second active pixel included in the active pixel array in response to the incident light;
reading the matching data indicating a second black region in the optical black pixel array corresponding to the second active pixel; and
collecting second dark signals that are generated by a plurality of second optical black pixels included in the second black region of the optical black pixel array.

7. The method according to claim 6, wherein the reading the matching data further includes:
determining positions of the plurality of second optical black pixels included in the second black region.

8. The method according to claim 6, wherein:
the second pixel signal is generated by converting the second pixel signal into a third digital signal; and
the second dark signals are generated by converting each of the second dark signals into a fourth digital signal.

9. The method according to claim 8, further comprising:
correcting the second pixel signal using the second dark signals
wherein the correcting the second pixel signal includes:
calculating a second average indicating an average of the fourth digital signals.

10. The method according to claim 9, wherein the correcting the second pixel signal further includes:
subtracting the second average from the third digital signal.

11. An imaging device comprising:
an image sensor including: a pixel array configured to generate a plurality of pixel signals in response to incident light; and a memory configured to store matching data for correcting the pixel signals,
wherein the pixel array includes:
an active pixel array including a plurality of active pixels configured to receive incident light to generate the plurality of pixel signals; and
an optical black pixel array including a plurality of optical black pixels configured to block incident light from being received by the optical black pixels to generate a plurality of dark signals indicating noise in the optical black pixels without being exposed to incident light for correcting the plurality of pixel signals,
wherein the matching data indicates a plurality of black regions in the optical black pixel array respectively corresponding to the plurality of active pixels.

12. The imaging device according to claim 11, wherein the matching data indicates a position of each of optical black pixels included in a black region of the plurality of black regions.

13. The imaging device according to claim 11, wherein the matching data includes:
information to match a plurality of active regions, obtained by dividing the active pixel array, with one of the black regions and match a plurality of active pixels included in each of the active regions with a same black region from among the black regions.

14. The imaging device according to claim 13, wherein:
an average of dark noises of active pixels included in an active region is equal to an average of dark noises of optical black pixels included in a black region matched with the active region.

15. The imaging device according to claim 11, wherein the image sensor further includes:
a readout circuit configured to convert each of the plurality of pixel signals and each of the plurality of dark signals into digital signals.

16. The imaging device according to claim 15, further comprising:
an image signal processor configured to calculate an average of the digital signals converted from the plurality of dark signals generated by optical black pixels included in the black region, subtracts the calculated average from the digital signal converted from a pixel signal generated by an active pixel matched with the black region, and corrects the pixel signal based on a result of subtraction.

17. The imaging device according to claim 16, wherein:
the plurality of active pixels includes a first active pixel configured to generate a first pixel signal, and a second active pixel configured to generate a second pixel signal; and
the plurality of black regions includes a first black region matched with the first active pixel, and a second black region matched with the second active pixel.

18. The imaging device according to claim 17, wherein the plurality of active pixels further includes:
a third active pixel configured to generate a third pixel signal,
wherein the third active pixel is matched with the first black region.

19. The imaging device according to claim 18, wherein:
a portion of the first black region is configured to overlap a portion of the second black region.

20. The imaging device according to claim 18, wherein:
the first black region is spaced apart from the second black region.
